(19) United States
(12) Patent Application Publication
(10) Pub. No.: US 2005/0165198 A1
(43) Pub. Date: Jul. 28, 2005

(54) Branched organosilicone compound

(76) Inventors: John Alfred Kilgour, Clifton Park, NY (US); Atchara Chaiyawat, Boston Lake, NY (US); Griffin Lai Kuo-Tsai, Clifton Park, NY (US)

Correspondence Address: Kenneth S. Wheelock;GE Plastics, One Plastics Avenue, Pittsfield, MA, 01201, US

(21) Appl. No.: 09/878,888

(22) Filed: Jun. 11, 2001

Related U.S. Application Data
(60) Provisional application No. 60/211,306, filed on Jun. 13, 2000.

(51) Int. Cl. C08G 77/04

(52) U.S. Cl. 528/34

(57) ABSTRACT

A branched organosiloxane compound contains a siloxane core and one or more hydrocarbon-terminated branches attached to the core, is useful as a component in personal care compositions.

### CROSS-REFERENCE TO RELATED APPLICATIONS

This application claims rights of priority from U.S. Provisional Patent Application Ser. No. 60/211,306, filed Jun. 13, 2000.

### FIELD OF THE INVENTION

The invention relates to silicone materials, more specifically, to organosiloxane compounds that exhibit branching.

### BRIEF DESCRIPTION OF THE RELATED ART

The personal care industry thrives on being able to deliver multiple performance products based on mixture of several components, with each having performance characteristics important to the final formulation. One important characteristic is the ability to provide a silky initial feel derived from low molecular weight silicones, such as for example, octamethylcyclotetrasilioxane or decamethylcyclopentasiloxane, in the formulation while maintaining a high but shear-thinnable viscosity. While these low molecular weight silicones provide the desired feel characteristics, they are also low viscosity, highly flowable liquids. Thus they are not easily held in a formulation, preferring rather to separate and flow out of a given container or flow uncontrollably when used in a specific application. Further, it desirable to achieve the initial silky feel while providing a smooth, low-residue sensory feel on dry-down. U.S. Pat. Nos. 5,493,041 and 4,987,169 and coassigned U.S. Pat. No. 5,760,116 each disclose the use of polymeric silicone gels prepared in volatile silicone oils to deliver the desirable initial feel of volatile, low viscosity silicones to formulations while at the same time provide high viscosity and a smooth silky feel on dry-down.

### SUMMARY OF THE INVENTION

In a first aspect, the present invention relates to a branched organosiloxane compound, comprising, per molecule of the compound, a silicone core and one or more hydrocarbon terminated branches attached to the silicone core.

In a second aspect, the present invention relates to a method for making a branched organosiloxane compound comprising contacting under hydrosilylation conditions, a silylhydride functional organosiloxane, a monoethylenically unsaturated hydrocarbon and a polyethylenically unsaturated siloxane resin.

In a third aspect, the present invention relates to a silicone composition, comprising:
(a) a network comprising two or more molecules of a branched organosiloxane compound; and
(b) a fluid within the network.

In a fourth aspect, the present invention relates to a personal care composition comprising a branched organosiloxane compound.

In a fifth aspect, the present invention relates to a method for making a personal care composition, comprising combining a personal care ingredient with a branched organosiloxane compound.

In sixth aspect, the present invention relates to a method for improving the sensory feel of a personal care composition while minimizing phase separation of the personal care composition, comprising adding a silicone composition, said silicone composition comprising a network, said network comprising two or more molecules of a branched organosiloxane compound, and a emollient fluid within the network, to the personal care composition.

In a seventh aspect, the present invention is directed to a method for reversibly imparting characteristics of a solid to a fluid, comprising combining the fluid with a branched organosiloxane compound, said branched organosiloxane compound comprising, per molecule of the compound, a silicone core and one or more hydrocarbon terminated branches attached to the silicone core, to form a network comprising two or more molecules of the branched organosiloxane compound with the fluid contained within the network.

In its various embodiments, the branched organosiloxane compound of the present invention exhibits a high affinity for a wide variety of fluids, including emollient fluids. The silicone composition of the present invention exhibits good stability, that is, a high resistance to separation of the fluid from the silicone composition. Personal care compositions containing branched organosiloxane compound and an emollient fluid, whether the branched organosiloxane compound and fluid are added separately to the personal care composition or added to the personal care composition in the form of the silicone composition of the present invention, exhibit improved sensory feel, leave a smooth silky feeling in the skin upon dry down, exhibit good film forming ability and exhibit good stability, that is, a high resistance to separation of the emollient fluid from the personal composition.

### DETAILED DESCRIPTION OF THE INVENTION

As used herein, the terminology “monoethylenically unsaturated” with respect to a compound means that the compound has one site of ethylenic unsaturation per molecule of the compound and the terminology “polyethylenically unsaturated” with respect to a compound means that the compound contains two or more ethylenically unsaturated sites per molecule of the compound.

In a preferred embodiment, the silicone core of the branched organosiloxane compound of the present invention comprises a silicone resin core. As used herein, the terminology “silicone resin core” means a silicone core comprising one or more siloxane units of the structural formula (I):
SiO_{4/2} (I).

In a preferred embodiment, the hydrocarbon terminated branches of the branched organosiloxane compound of the present invention comprise monovalent hydrocarbon radicals that are each covalently bonded, either directly or indirectly, such as, for example, via a divalent organosiloxane group, to a silicon atom of the silicone core of the branched organosiloxane compound of the present invention.

In a highly preferred embodiment, the silicone core of the branched organosiloxane compound of the present invention comprises (a) two or more siloxane nodes, each node comprising one or more siloxane units of the structural formula (I) and (b) one or more organosiloxane bridging groups connecting the siloxane nodes, each organosiloxane bridge comprising one or more organosiloxane units selected from units of one or more of the structural formulas (II), (III) and (IV):
R¹₃SiO_{1/2} (II)
R²₂SiO_{2/2} (III)
R³SiO_{3/2} (IV)
wherein each R¹, R² and R³ is independently hydrocarbon radical. In a preferred embodiment, one or more of the R¹, R² and R³ groups represent at least a portion of the hydrocarbon terminated branches of the branched organosiloxane compound of the present invention.

In a preferred embodiment, the branched organosiloxane compound comprises one or more structural units according to formula (II) which are each covalently bonded, either directly or indirectly, such as for example, through a divalent organosiloxane group, to a SiO_{4/2} structural unit of the silicone resin core. In a preferred embodiment, the R¹ substituents of such one or more structural units according to formula (II) represent at least a portion of the hydrocarbon terminated branches of the branched organosiloxane compound of the present invention.

As used herein “hydrocarbon radical” includes acyclic hydrocarbon radicals, alicyclic hydrocarbon radicals and aromatic hydrocarbon radicals.

As used herein, the terminology “acyclic hydrocarbon radical” means a straight chain or branched hydrocarbon radical, preferably containing from 1 to 80 carbon atoms per radical, which may be saturated or unsaturated and which may be optionally substituted or interrupted with one or more functional groups, such as, for example, carboxyl, cyano, hydroxy, halo and oxy. Suitable acyclic hydrocarbon radicals include, for example, alkyl, alkenyl, alkynyl, hydroxyalkyl, cyanoalkyl, carboxyalkyl, carboxamide, alkylamido and haloalkyl, such as, for example, methyl, ethyl, sec-butyl, tert-butyl, octyl, decyl, dodecyl, cetyl, stearyl, ethenyl, propenyl, butynyl, hydroxypropyl, cyanoethyl, carboxymethyl, chloromethyl and 3,3,3-fluoropropyl. Additionally the terminology “acyclic hydrocarbon radical” includes two different sub-classes of hydrocarbon radicals that are simultaneously substituents in the molecules of the present invention, the first sub-class being hydrocarbon radicals as previously defined having from 1 to 70 carbon atoms per radical, preferably from 1 to 60 carbon atoms per radical, more preferably 1 to 50 carbon atoms per radical and most preferably 1 to 40 carbon atoms per radical while the second sub-class of hydrocarbon radicals has from 1 to 80 carbon atoms per radical, preferably from 20 to 80 carbon atoms per radical, more preferably 30 to 80 carbon atoms per radical and most preferably 40 to 80 carbon atoms per radical. Thus an embodiment of the present invention comprising methyl and stearyl substituents comprises elements of both sub-classes.

As used herein the term “alkyl” means a saturated straight or branched hydrocarbon radical. In a preferred embodiment, monovalent alkyl groups are selected from linear or branched alkyl groups containing from 1 to 80 carbons per group, such as, for example, methyl, ethyl, propyl, iso-propyl, n-butyl, iso-butyl, sec-butyl, tert-butyl, pentyl, hexyl, heptyl, decyl, dodecyl, eicosyl.

As used herein the term “alkenyl” means a straight or branched terminally unsaturated hydrocarbon radical, preferably containing from 2 to 10 carbon atoms per radical, such as, for example, ethenyl, 2-propenyl, 3-butenyl, 5-hexenyl, 7-octenyl and ethenylphenyl.

As used herein, the terminology “alicyclic hydrocarbon radical” means a radical containing one or more saturated hydrocarbon rings, preferably containing from 4 to 10 carbon atoms per ring, per radical which may optionally be substituted on one or more of the rings with one or more alkyl radicals, each preferably containing from 2 to 6 carbon atoms per group, halo radicals or other functional groups and which, in the case of an alicyclic hydrocarbon radical containing two or more rings, may be fused rings. Suitable monovalent alicyclic hydrocarbon radicals include, for example, cyclohexyl and cyclooctyl.

As used herein, the terminology “aromatic hydrocarbon radical” means a hydrocarbon radical containing one or more aromatic rings per radical, which may, optionally, be substituted on the aromatic rings with one or more alkyl radicals, each preferably containing from 2 to 6 carbon atoms per group, halo radicals or other functional groups and which, in the case of an aromatic hydrocarbon radical containing two or more rings, may be fused rings. Suitable aromatic hydrocarbon radicals include, for example, phenyl, tolyl, 2,4,6-trimethylphenyl, 1,2-isopropylmethylphenyl, 1-pentalenyl, naphthyl, anthryl.

In a preferred embodiment, a hydridosiloxane, preferably, a terminal dihydridosiloxane, is reacted with an ethylenically unsaturated hydrocarbon, preferably a terminally monoethylenically unsaturated hydrocarbon, to produce a reaction intermediate comprising hydrocarbon-substituted siloxane chains. The reaction intermediate is then reacted with a ethylenically unsaturated silicone resin to produce a soluble polymeric system with pendant branches consisting of siloxane chains terminated with the hydrocarbon substituents.

In preferred embodiment, the branched organopolysiloxane compound of the present invention is made by hydrosilylation of an ethylenically unsaturated hydrocarbon and an ethylenically unsaturated siloxane resin with a silylhydride functional organosiloxane, preferably comprising a silylhydride terminated organosiloxane according to the structural formula (VI):
M^{H}ₐD_{b}D^{H}_{c}T_{d}T^{H}ₑ (VI)
wherein
M is R⁵₃SiO_{1/2}
M^{H} is HR⁶₂SiO_{1/2},
D is R⁷₂SiO_{2/2},
D^{H} is HR⁸SiO_{2/2}
T is R⁹SiO_{3/2},
T^{H} is HSiO_{3/2},
   wherein each R⁵, R⁶, R⁷, R⁸ and R⁹ is independently a hydrocarbon radical and a, b, c, d and e are each integers selected to provide a compound a having a viscosity of from 1 to 1,000,000 cSt, more preferably from 1 to 100,000 cSt, and having a desired amount of silylhydride groups per molecule.

In a preferred embodiment, the ethylenically unsaturated hydrocarbon comprises a terminally monoethylenically unsaturated hydrocarbon according to the structural formula (VII):
CH₂═CHR¹⁰ (VII)
wherein each R¹⁰ is independently a monovalent hydrocarbon radical.

In a preferred embodiment, the ethylenically unsaturated siloxane resin comprises a polyethylenically unsaturated siloxane resin of the structural formula (VIII):
(M^{vi}₂Q)₄ (VIII)
wherein M^{vi} is R¹¹R¹²SiO_{1/2}, wherein each R¹¹ is independently a monovalent hydrocarbon radical, each R¹² is alkenyl and Q is SiO_{4/2}.

In a preferred embodiment, each R⁵, R⁶, R⁷, R⁸, R⁹ and R¹¹ is independently alkyl, hydroxyalkyl, a polyhydric alcohol radical, monocyclic aromatic, aralkyl, oxaalkylene or alkylcarbonyloxaalkylene.

More preferably, each R⁵, R⁶, R⁷, R⁸, R⁹ and R¹¹ is independently (C₁-C₈₀)alkyl, hydroxy(C₁-C₁₂)alkyl, a polyhydric alcohol radical according to formula (IX), (X) or (XI)
—R¹³—CHOHCH₂OH (IX)
—R¹⁴—CHOHCH₂CH₂OH (X)
—R¹⁵—C(R¹⁶)₃ (XI)
wherein each R¹³, R¹⁴ and R¹⁵ is independently (C₁-C₁₂)alkylene or (C₁-C₁₂)oxaalkylene and each R¹⁶ is independently H, hydroxy, (C₁-C₁₂)alkyl, or hydroxy(C₁-C₁₂)alkyl, provided that at least two R¹⁶ substituents per radical are hydroxy or hydroxy(C₁-C₁₂)alkyl, aralkyl according to the formula (XII): 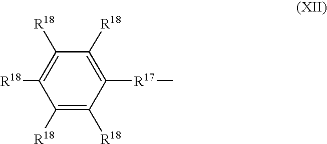
wherein R¹⁷ is (C₁-C₆)alkylene and each R¹⁸ is independently H, hydroxyl, (C₁-C₆)alkyl, hydroxy(C₁-C₆)alkyl, or —OCOR¹⁹, wherein R¹⁹ is (C₁-C₆)alkyl,
oxaalkylene according to formula (XIII) or (XIV):
   —(CH₂)_{f}O(CR²⁰H)_{g}— (XIII)
   —(CH₂)ₕ(O(CR²¹H)ᵢ)ⱼ(CH₂)ₖ— (XIV)
   wherein each R²⁰ and R²¹ is independently H or alkyl, preferably (C₁-C₈)alkyl, and each f, g, h, i, j and k is independently an integer of from 1 to 20, or alkylcarbonyloxaalkylene according to formula (XV):
   R²²—C—R²³₃ (XV)
   wherein R²² is (C₁-C₁₂)alkylene or (C₁-C₁₂)oxaalkylene and each R²³ is independently H, (C₁-C₂₄)alkyl, or —OCOR²⁴, wherein each R²⁴ is independently (C₁-C₂₄)alkyl, provided that at least one R²³ group per radical is —OCOR²⁴.

Suitable silylhydride terminated organosiloxanes include, for example, silylhydride terminated polydimethylsiloxanes.

Suitable monoethylenically unsaturated hydrocarbon compounds include, for example, polyolefins, allyl polyethers, allyl esters, vinyl aromatics, monoethylenically unsaturated alcohols.

Suitable polyethylenically unsaturated siloxane resins include, for example, vinyl functional MQ resins.

In one preferred embodiment, the silylhydride terminated organosiloxane compound according to formula (XVI) below is contacted under hydrosilylation conditions with less than its molar equivalent amount, based on relative moles of silylhidride groups and ethylenically unsaturated groups, of a monoethylenically unsaturated hydrocarbon compound according to formula (VII) above to form a reaction intermediate comprising a mixture of products according to the structural formulae (XVI), (XVII) and (XVIII):
M^{H}DₙM^{H} (XVI)
M¹DₙM^{H} (XVII) and
M¹DₙM¹ (XVIII)
wherein M¹ is R²⁵R⁶₂SiO_{1/2}, wherein R²⁵ is —(CH₂)₂R¹⁰, and wherein M^{H}, D, R⁶ and R¹⁰ are each defined as above, n is an integer selected to provide a compound a having a viscosity of from 1 to 1,000,000 cSt, more preferably from 1 to 100,000 cSt, and the reaction intermediate is then reacted with the ethylenically unsaturated siloxane resin to form a branched organopolysiloxane compound.

In an alternative preferred embodiment, a silylhydride functional organosiloxane is contacted under hydrosilylation conditions with less than its molar equivalent amount of a monoethylenically unsaturated hydrocarbon, wherein the molar equivalent amount is based on relative moles of silylhidride groups of the organosiloxane and ethylenically unsaturated groups of the hydrocarbon, and less than its molar equivalent amount of a polyethylenically unsaturated siloxane resin, wherein the molar equivalent amount is based on relative moles of silylhidride groups of the organosiloxane and ethylenically unsaturated groups of the resin, in a single step to form the branched siloxane compound of the present invention.

In another alternative preferred embodiment, a silylhydride functional organosiloxane contacted under hydrosilylation conditions with less than its molar equivalent amount, based on relative moles of silylhidride groups and ethylenically unsaturated groups, of a polyethylenically unsaturated siloxane resin in a first step and then contacted under hydrosilylation conditions with a monoethylenically unsaturated hydrocarbon to form the branched siloxane compound of the present invention.

The method of polymer synthesis provides for incorporation of a wide range of organofunctional groups into the copolymeric structure. Thus, the inclusion of other organofunctional groups, such as, for example, organic epoxides, epoxysiloxanes, terminally unsaturated organic and alkenylsiloxane compounds can be used to modify the resulting copolymers.

In one embodiment, the organofunctional groups are introduced to the network as R⁵, R⁶, R⁷, R⁸, R⁹ and R¹¹ radicals present on a silylhydride functional organosiloxane according to formula (VI) or the ethylenically unsaturated siloxane resin according to formula (VIII) above. In an alternative embodiment, the organofunctional groups are introduced to the network during hydrosilylation of the silylhydride functional organosiloxane and the ethylenically unsaturated reactants by including organofunctional compounds, for example ethylenically unsaturated organofunctional groups, to the reaction mixture which are copolymerizable with the silylhydride functional organosiloxane under the chosen polymerization reaction conditions. For example, the silylhydride functional organosiloxane, ethylenically unsaturated hydrocarbon and ethelynically unsaturated siloxane resin may be polymerized in the presence of other reactants, such as for example alkenyl functional silicone compounds, alkenyl functional organic compounds or silylhydride functional compounds which contain the desired organodfunctional groups and which areare reactive with or copolymerizable with the silylhydride functional organosiloxane, ethylenically unsaturated hydrocarbon and ethelynically unsaturated siloxane resin under the reaction conditions used and the polymer network may, accordingly, include structural units derived from such other reactants.

In a highly preferred embodiment, the branched organosiloxane compound formed by any of the above alternative processes is then treated with a terminally monoethylenically unsaturated hydrocarbon according to structural formula (VI) under hydrosilylation conditions to cap any remaining silylhydride functional groups.

In contrast to the cross-linked, insoluble silicone gel materials, such as, for example, those disclosed in coassigned U.S. Pat. No. 5,760,116, the branched organosiloxane compound of the present invention has a finite molecular weight and is soluble in, for example, benzene, i.e. the compounds of the present invention are benzene soluble. In preferred embodiment, the branched organosiloxane compound has a number average or weight average molecular weight of less than about 10,000,000, more preferably a number average or weight average molecular weight from about 1,000 to about 10,000,000, even more preferably from about 10,000 to about 5,000,000.

In a preferred embodiment, at least one step of the synthesis of the branched organopolysiloxane compound of the present invention is carried out in the presence of a fluid to produce a network of branched organosiloxane molecules having the fluid within the network.

In an alternative embodiment, the silicone material of the present invention is made by synthesizing the branched organopolysiloxane compound in the absence of fluid, followed by the subsequent addition of a fluid to produce a network of branched organosiloxane molecules having the fluid within the network.

In another alternative embodiment, the silicone material of the present invention is made by synthesizing the branched organopolysiloxane compound of the present invention in the presence of a first fluid such as for example a volatile hydrocarbon fluid, followed by removal of the first fluid, such as, for example by evaporation of the first fluid, and the subsequent addition of a second fluid such as for example, a siloxane fluid, to produce a network of branched organosiloxane molecules having the second fluid within the network.

As used herein, the terminology “network” means a three dimensionally extending structure comprising two or more molecules of the branched organosiloxane compound. Preferably, fluid is contained within interstices of the network. As used herein, the term “interstices” is used in reference to the network to denote spaces within the network, that is, spaces between the molecules of the branched organosiloxane compound of the network.

The network structure comprises a plurality of molecules of the branched organosiloxane compound, associated via intermolecular attractions between the molecules of the branched organosiloxane compound. Molecules of the branched organosiloxane compound associate to form a network structure when the branched organosiloxane compound is present in a sufficiently high concentration. While not wishing to be bound by theory, it is believed that in those embodiments of the present invention which include waxy hydrocarbon subustituent-terminated branches, the crystallization of the waxy substituent groups of different molecules of the branched organosiloxane compound is the predominant mode of intermolecular attraction that leads to formation of the network. As the concentration of branched organosiloxane compound by diluting the mixture with a suitable fluid, for example, an emollient fluid or a silicone fluid, the magnitude of the intermolecular attractions between the molecules of the branched organosiloxane compound decrease and, at sufficiently high dilution, the mixture forms a solution of the branched organosiloxane compound in the fluid.

In a preferred embodiment, the silicone composition of the present invention comprises, based on 100 parts by weight (“pbw”) of the silicone composition, from 0.1 pbw to 99 pbw, more preferably from 1.0 pbw to 90 pbw, even more preferably from 2 pbw to 40 pbw, of the branched organosiloxane compound of the present invention and from 1 pbw to 99.9 pbw, more preferably from 10 pbw to 99 pbw, even more preferably from 60 pbw to 98 pbw, of the fluid.

The silicone composition may be further processed under low to high shear to adjust the viscosity and sensory feel of the composition. This may be achieved, for example, by subjecting the composition to a moderate to high shearing force. High shear may be applied using, for example, a Sonolator apparatus, a Gaulin Homogenizer or a Micro Fluidizer apparatus. Optionally, more fluid may be added prior to the shearing.

In a preferred embodiment, the silicone composition of the present invention is a solid, typically having a creamy consistency, wherein the network acts as a means for reversibly imparting characteristics of a solid to the fluid. At rest, the silicone composition exhibits the properties of a solid. The silicone composition of the present invention exhibits high stability and resistance to syneresis, that is, the composition exhibits little or no tendency for fluid to flow from the composition and imparts high stability and syneresis resistance to personal care compositions which include the silicone composition as a component. The high stability and syneresis resistance persists with prolonged aging of such silicone compositions and personal care compositions. However, fluid may be released from the network by subjecting the silicone composition to a shearing force, such as, for example, by rubbing the composition between one's fingers, to provide improved sensory feel characteristic of the fluid component of the silicone material.

Fluids suitable for use as the fluid component of the composition of the present invention are those compounds or mixtures of two or more compounds that are in the liquid state at or near room temperature, for example, from about 20° C. about 50° C., and about one atmosphere pressure, and include, for example, silicone fluids, hydrocarbon fluids, esters, alcohols, fatty alcohols, glycols and organic oils. In a preferred embodiment, the fluid component of the composition of the present invention exhibits a viscosity of below about 1,000 centistokes, preferably below about 500 centistokes, more preferably below about 250 centistokes, and most preferably below 100 centistokes, at 25° C.

The characterization of one embodiment of the branched organosiloxane compound as being swellable by the fluid means that the embodiment of the branched organosiloxane compound is capable of absorbing the fluid. In a highly preferred embodiment, the composition of the branched organosiloxane compound is tailored to enhance its compatibility with the fluid. For example, if the branched organosilioxane compound network is to be swollen with a hydrocarbon fluid, then the hydrocarbon character of the branched organosilioxane compound may be increased by increasing the number and/or the carbon chain length of the organic substituents of the polyfunctional organosilicone compound used to form the polymer network.

In a preferred embodiment, the fluid component of the present invention comprises an emollient compound. Suitable emollient compound include any fluid that provides emollient properties, that is, that when applied to skin, tend to remain on the surface of the skin or in the stratum corneum layer of the skin to act as lubricants, reduce flaking and to improve the appearance of the skin. Emollient compounds are generically known and include, for example, hydrocarbons, such as for example, isododecane, isohexadecane, hydrogenated polyisobutene, organic waxes, such as for example, jojoba, silicone fluids, such as, for example, cyclopentasiloxane, dimethicone, bis-phenylpropyl dimethicone, esters, such as, for example, octyldodecyl neopentanoate, oleyl oleate, as well as fatty acids and alcohols, such as for example, oleyl alcohol, isomyristyl alcohol.

In a highly preferred embodiment, the fluid component of the present invention comprises a silicone fluid, more preferably a silicone fluid that exhibits emollient properties. Suitable silicone fluids include, for example, cyclic silicones of the formula Dₒ, wherein D is defined as above, R⁷ is preferably methyl, and r is an integer wherein 3≦0≦12, such as, for example, hexamethylcyclotrisiloxane (“D₃”), octamethylcyclotetrasiloxane (“D₄”), decamethylcyclopentasiloxane (“D₅”), and dodecamethylcyclohexasiloxane (“D₆”), as well as linear or branched organopolysiloxane fluids according to the formula (XIX):
M′ₚD′_{q}T′ᵣ (XIX)
wherein:
M′ is R²⁶₃SiO_{1/2};
D′ is R²⁷2SiO_{2/2}
T′ is R²⁸SiO_{3/2}
R²⁶, R²⁷ and R²⁸ are each independently alkyl, aryl or aralkyl;
p, q and r are zero or positive integers, wherein p=(2+r), 0≦q≦300, and when p and r are zero, q is 3 or greater; preferably 0≦q≦100,
more preferably 0≦q≦50, and even more preferably 0≦q≦20, and 0≦r≦100.

The personal care applications where the branched organosiloxane compound of the present invention and the silicone composition of the present invention may be employed include, but are not limited to, deodorants, antiperspirants, antiperspirant/deodorants, shaving products, skin lotions, moisturizers, toners, bath products, cleansing products, hair care products such as shampoos, conditioners, mousses, styling gels, hair sprays, hair dyes, hair color products, hair bleaches, waving products, hair straighteners, manicure products such as nail polish, nail polish remover, nails creams and lotions, cuticle softeners, protective creams such as sunscreens, insect repellents and anti-aging products, color cosmetics such as lipsticks, foundations, face powders, eye liners, eye shadows, blushes, makeup, mascaras and other personal care formulations where silicone components have been conventionally been added, as well as drug delivery systems for topical application of medicinal compositions that are to be applied to the skin.

In a preferred embodiment, the personal care composition of the present invention comprises one or more personal care ingredients. Suitable personal care ingredients include, for example, emollients, including, for example, the emollient fluids discussed above, moisturizers, humectants, water soluble dyes, liposoluble dyes, pigments, including pearlescent pigments such as, for example, bismuth oxychloride and titanium dioxide coated mica, colorants, fragrances, biocides, preservatives, antioxidants, anti-microbial agents, anti-fungal agents, antiperspirant agents, exfoliants, hormones, enzymes, medicinal compounds, vitamins, salts, electrolytes, alcohols, polyols, absorbing agents for ultraviolet radiation, botanical extracts, surfactants, silicone oils, organic oils, waxes, film formers, thickening agents such as, for example, fumed silica or hydrated silica, particulate fillers, such as for example, silica, talc, kaolin, starch, modified starch, mica, nylon, polyethylene powder, poly(methyl methacrylate) powder and clays, such as, for example, bentonite and organo-modified clays.

Suitable personal care compositions are made by combining, in a manner known in the art, such as, for example, by mixing, one or more of the above components with the silicone network of the present invention or with the silicone composition of the present invention. Suitable personal care compositions may be in the form of a single phase or in the form of an emulsion, including oil-in-water, water-in-oil and anhydrous emulsions, as well as multiple emulsions, such as, for example, oil-in water-in-oil emulsions and water-in-oil-in water-emulsions.

In a preferred embodiment, an antiperspirant composition comprises a silicone material according to the present invention and one or more active antiperspirant agents. Suitable antiperspirant agents include, for example, the Category I active antiperspirant ingredients listed in the U.S. Food and Drug Administration's Oct. 10, 1993 Monograph on antiperspirant drug products for over-the-counter human use, such as, for example, aluminum halides, aluminum hydroxyhalides, for example, aluminum chlorohydrate, and complexes or mixtures thereof with zirconyl oxyhalides and zirconyl hydroxyhalides, such as for example, aluminum-zirconium chlorohydrate, aluminum zirconium glycine complexes, such as, for example, aluminum zirconium tetrachlorohydrexgly.

In a preferred embodiment, a skin care composition comprises silicone material of the present invention and a vehicle, such as, for example, a silicone oil or an organic oil. The skin care composition may, optionally, further include emollients, such as, for example, triglyceride esters, wax esters, alkyl or alkenyl esters of fatty acids or polyhydric alcohol esters and one or more the known components conventionally used in skin care compositions, such as, for example, pigments, vitamins, such as, for example, Vitamin A, Vitamin C and Vitamin E, sunscreen or sunblock compounds, such as, for example, titanium dioxide, zinc oxide, oxybenzone, octylmethoxy cinnamate, butylmethoxy dibenzoylmethane, p-aminobenzoic acid and octyl dimethyl-p-aminobenzoic acid.

In a preferred embodiment, a color cosmetic composition, such as, for example, a lipstick, a makeup or a mascara composition comprises a silicone material according to the present invention, an emollient compound and one or more coloring agents, such as, for example, pigments, water soluble dyes or liposoluble dyes.

The compositions of the present invention may be utilized directly as silicone compositions or as emulsions. As emulsions they may be utilized as silicone in water (oil-in-water) emulsions or as water in silicone (water-in-oil) emulsions. They may also be utilized as non-aqueous emulsions between immiscible non-aqueous phases where the silicone comprising phase is the discontinuous phase of the emulsion or where the silicone comprising phase is the continuous phase of the emulsion. Non-aqueous emulsions comprising a silicone phase are described in U.S. Pat. No. 6,060,546 and co-pending application U.S. Ser. No. 09/033,788 filed Mar. 3, 1998 the disclosures of which are herewith and hereby specifically incorporated by reference. As used herein the term “emulsion” includes but is not limited to micro-emulsions and emulsions within emulsions.

The following examples are by way of illustration only and are not intended to limit the appended claims in any fashion.

### EXAMPLE 1

A branched organopolysiloxane compound of the present invention was made as follows. 7.5 grams (0.00797 moles) of terminally unsaturated (C₃₀₊)hydrocarbon wax (Gulftene 30+, Chevron) was mixed with 100 grams (0.0207 moles) of a silylhydride terminated organosiloxane of the structural formula M^{H}D₁₂₅ M^{H}, wherein M^{H} and D are each defined as above and R⁴ and R⁵ are each methyl, and 0.00504 grams of 10% platinum catalyst. The mixture was heated for two hours at 80° C. to allow the wax to react on the ends of the silylhydride fluid. An amount (0.97 grams) of an organosiloxane resin according to the structural formula (M^{vi}₂Q)₄, wherein M^{vi} and Q are each defined above, R⁸ is ethenyl and R⁹ is methyl, to provide 0.0093 moles of vinyl equivalents was then added to the reaction mixture along with an additional 0.00504 grams of platinum catalyst. The reaction mixture was again heated to 90-95° C. for two hours to allow reaction. An additional 3.23 grams of the terminally unsaturated wax (0.0062 moles) was then added and again the reaction was heated to 90-95° C. for two hours. The reaction product was a high viscosity, flowable liquid that solidified on cooling. An SiH test showed that the SiH had been consumed during the reaction.

### EXAMPLE 2 AND COMPARATIVE EXAMPLE C1

The antiperspirant compositions of Example 2 and Comparative Example C1 were made by combining the ingredients set forth below in the relative amounts listed in TABLE I below. Unless otherwise specified, all the relative amounts of the ingredients of the compositions of the examples and comparative examples disclosed below are given in pbw per 100 pbw of the composition, with the notation “q.s.” used with some ingredients, for example, a fragrance, where the amount of the ingredients is not critical, to indicate a non-measured sufficient amount of the ingredient

TABLE I

| Ingredients | CEx. C1 | Ex 2 |
|---|---|---|
| (C₃₀-C₄₅)allyl dimethicone wax | 6 | — |
| Compound of Example 1 | — | 6 |
| Cyclopentasiloxane | 45 | 45 |
| Hydrogenated castor oil | 5 | 5 |
| (C₁₂-C₁₅)alkyl benzoate | 14 | 14 |
| Talc | 5 | 5 |
| ZAG | 25 | 25 |

The antiperspirant compositions of Example 2 and Comparative Example C1 were each evaluated for evidence of syneresis by maintaining the compositions at room temperature, with syneresis indicated by phase separation. Neither composition showed any evidence of syneresis after one week.

The spreadability of the each of compositions of Example 2 and Comparative Example C1 were evaluated by spreading the samples on the forearms of a test subject and evaluating the ease of moving the composition over the skin surface. Both compositions exhibited high spreadability.

The composition of Example 2 provided softer feel during rub on when compared to the composition of Comparative Example C1.

### EXAMPLE 3 AND COMPARATIVE EXAMPLE C2

The white antiperspirant sticks of Example 3 and Comparative Example C2 were made by combining the ingredients in the relative amounts set forth below in Table II. The cyclopentasiloxane, stearyl alcohol, hydrogenated castor oil, PPG-2 myristyl ether proprionate and in Example 3, the material of Example 1, were combined and heated to 65° C. Talc and ZAG were then added to the heated mixture which was then mixed until uniform and poured into containers.

TABLE II

| Ingredients | CEx C2 | EX 3 |
|---|---|---|
| Cyclopentasiloxane | 54 | 49 |
| Compound of Example 1 | — | 5 |
| ZAG | 24 | 24 |
| Stearyl alcohol | 14 | 14 |
| PPG-2 myristyl ether proprionate | 1 | 1 |
| Talc | 3 | 3 |
| Hydrogenated castor oil | 4 | 4 |

After 24 hours, the antiperspirant sticks were evaluated for an anti-whitening effect and the ability to hold cyclopentasiloxane and PPG-2 myristyl ether proprionate into the stick. The test for the anti-whitening effect was performed by applying 200 mg of antiperspirant (formulations listed above) on 5 cm×11 cm black tiles. A Minolta CR300 Colorimeter was used to quantify the whitening after 2 hours by measuring L-values on L,a,b color scale which represents whiteness.
% whitening reduction=(L₀−L)/L₀×100
where L₀ is L value of control(C2), and L is L value of the tested formulation (Example 3). The antiperspirant stick of Example 3 showed % whitening reduction of 43% (L₀=58.69, L=33.57).

The ability of each of the antiperspirant sticks to hold cyclopentasiloxane and PPG-2 myristyl ether proprionate in the respective stick was performed by pressing a thumb on the surface of the stick and observed the fluid squeezing out. The antiperspirant stick of Example 3 showed no leakage whereas the antiperspirant stick of Comparative Example C2 showed the fluid weeping. The antiperspirant stick of Example 3 was also harder than that of C2. This indicates that material Example 1 has the ability to hold emollient fluids in addition to its gelling property. Both samples were applied on skin. The antiperspirant stick of Example 3 provided superior glide compared to that of Comparative Example C2. In general, superior glide results in a uniform active salt deposition on skin.

### EXAMPLE 4 AND COMPARATIVE EXAMPLE C3

The oil-in-water emulsion compositions of Example 4 and Comparative Example C3, each useful, for example, as a skin lotion, were made by combining the ingredients in the relative amounts listed below in Table III and assessing skin feel.

TABLE III

| Ingredients | CEx C3 | Ex 4 |
|---|---|---|
| Part A | | |
| Water | 76.4 | 71.4 |
| Disodium EDTA | 0.05 | 0.05 |
| Methylparaben | 0.2 | 0.2 |
| Propylparaben | 0.1 | 0.1 |
| 2% Carbomer (Carbopol 934) | 20 | 20 |
| Part B | | |
| Glyceryl stearate and PEG-100 | 1.6 | 1.6 |
| stearate (Arlacel165) | | |
| Vitamin E | 0.5 | 0.5 |
| Compound of Example 1 | — | 5 |
| Part C | | |
| DI Water | 1 | 1 |
| 99% TEA | 0.15 | 0.15 |

Each of the emulsion compositions of Example 4 and Comparative Example C3 was made by: (1) heating Part A and Part B in separate vessels to 70° C. with moderate agitation, (2) adding Part B to Part A under homogenization, (3) cooling the mixture so formed to 40° C. and adding Part C as ordered, and (4) pouring the cooled mixture into containers.

Sensory evaluation was performed on both samples by rubbing samples on skin. Initial feel was similar, but the emulsion of Example 4 provided better spreadability and a more silky feel upon rubbing than that of Comparative Example C3.

### EXAMPLE 5 AND COMPARATIVE EXAMPLE C4

Lipstick examples comprising the ingredients listing below were made by combining the ingredients in the relative amounts set forth below in Table IV. The cyclopentasiloxane, cetearyl methicone or silicone composition of Example 1 and the pigment were combined and heated to 65° C. The mica was then added to the heated mixture and mixed well.

TABLE IV

| Ingredients | CEx C4 | Ex 5 |
|---|---|---|
| Cyclopenatasiloxane | 50 | 50 |
| Compound of Example 1 | 0 | 40 |
| Cetearyl methicone | 40 | 0 |
| D&C Red #7 Ca lake | 8 | 8 |
| Mica | 2 | 2 |

Each of the compositions were evaluated for appearance and durability after 24 hour. The lipstick of Comparative Example 4 formed a stick, whereas The lipstick of Example 5 was a soft solid lipstick with a deeper color and more glossy. Both samples were then tested for durability by applying material on 5 cm×11 cm black tiles. Then the tiles were rinsed with water for 60 sec and the amount of material left on each tile was evaluated. The lipstick of Comparative Example C4 was washed away clean, while the lipstick of Example 5 remained on the tile, showing high water repellency and durability.

### EXAMPLE 6 AND COMPARATIVE EXAMPLE C5

The water-in-oil emulsion compositions of Example 6 and Comparative Example C5 were made by combining the ingredient in the relative amounts set forth below in Table V. Parts A and B were separately prepared and then combined.

TABLE V

| Ingredients | CEx C5 | Ex 6 |
|---|---|---|
| Part A | | |
| Cyclopentasiloxane and Dimethicone Copolyol | 10 | 10 |
| Cyclopentasiloxane | 16 | 8 |
| Compound of Example 1 | — | 8 |
| Sorbitan oleate | 0.6 | 0.6 |
| Part B | | |
| Glycerin | 1 | 1 |
| NaCl | 1 | 1 |
| Germaben II | 1 | 1 |
| Water | 70.4 | 70.4 |

The appearance, thickening effect and skin feel of the emulsions were then evaluated. Sensory evaluation was conducted by applying skin cream on forearm and assessing skin feel of the composition of Example 6 compared to that of Comparative Example C5. The thickening effect was identified by measuring viscosity of the formulations after 24 hour by using a Brookfield viscometer with a t-spindle and heliopath stand. Results of the evaluations are set forth below in Table VI.

TABLE VI

| | CEx C5 | Ex 6 |
|---|---|---|
| Appearance after 24 hr | Pourable lotion | Thick cream |
| at RT | | |
| Viscosity at 25° C., | 11,232 | 374,400 |
| centiPoise | | |
| Skin feel | Initial light feel during | Substantive soft smooth |
| | rub in, and high | feel after water |
| | spreadability | evaporated off, and |
| | | moderate spreadability |

### EXAMPLE 7

The sunscreen lotion composition of Example 7 is made by combining the ingredients in the relative amounts set forth below in Table VII according to the procedure outlined below and gives good skin feel and water repellency.

TABLE VII

| | Relative |
|---|---|
| Ingredient | Amount |
| PART A | |
| Deionized Water | q.s. |
| Tetrasodium EDTA | 0.05 |
| PEG-8 | 4.00 |
| Phenoxyethanol, Methylparaben, Butylparaben, | 0.25 |
| Ethylparaben and Propylparaben | |
| Magnesium Aluminum Silicate | 0.25 |
| PART B | |
| Compound of Example 1 | 7.00 |
| Octyl Methoxycinnamate | 7.00 |
| Octyl Salicylate | 3.00 |
| Benzophenone-3 | 3.00 |
| (C₁₀₋₃₀)alkylacrylate Crosspolymer | 0.30 |
| Carbomer (Carbopol 934) | 0.15 |
| Sorbitan Oleate | 0.20 |
| PART C | |
| Fragrance | 0.12 |
| PART D | |
| Triethanolamine 99% | 0.55 |

The ingredients are combined according to the following procedure: (1) make Part A by (a) heating water of Part A to 75° C., (b) adding remaining ingredients in order with moderate propeller agitation, making sure that all paraben components have dissolved, (c) mixing for 15 minutes, while cooling to 50° C., (2) combine the ingredients of Part B with sweep agitation at ambient temperature and mix until a smooth “paste” is obtained, (3) add Part B at room temperature to Part A (at 50° C.) with rapid propeller agitation and mix for 30 minutes or longer to ensure that the polymers are completely dispersed, (4) cool with agitation to 45° C. (5) add Part C to batch with moderate propeller agitation and mix 10 minutes, and (6) add Part D to batch at 40° C., mix with moderate agitation for 20 minutes and cool to room temperature.

### EXAMPLE 8

The foundation composition of Example 8 is made by combining the ingredients in the relative amounts set forth below in Table IX according to the procedure set forth below provides superior for long wear and silky light feel.

TABLE IX

| | Relative |
|---|---|
| Ingredient | Amount |
| PART A | |
| Cyclopentasiloxane and Dimethicone Copolyol | 12.0 |
| Cyclopentasiloxane | 20.0 |
| Compound of Example 1 | 5.0 |
| Polymethylsilsesquioxane (TOSPEARL ® 2000) | 2.0 |
| Titanium Dioxide | 6.0 |
| Iron Oxides | 2.1 |
| PART B | |
| 1% NaCl in Deionized Water | 49.95 |
| Polysorbate-20 | 0.85 |
| Glycerin | 2.0 |
| Preservative | q.s. |
| Fragrance | q.s. |

The ingredients are combined by the following procedure: (1) combine the ingredients of Part A, in order shown, thoroughly mixing each component until homogenous before adding the next ingredient, (2) in a separate vessel, combine ingredients of Part B in order shown, (3) slowly add Part B to Part A with good mixing. Increase agitation, as mixture thickens.

### EXAMPLE 9

The shampoo composition of Example 9 is made by combining the ingredients in the relative amounts set forth below in Table X according to the procedure set forth below provides good conditioning to hair fibers.

TABLE X

| Ingredient | Relative Amount |
|---|---|
| PART A | |
| Deionized water | q.s. |
| Ammonium Lauryl Sulfate (26%) | 24.00 |
| Ammonium Laureth Sulfate (28%) | 14.30 |
| Cocamidopropyl Betaine | 6.00 |
| Part B | |
| Cocamide MEA | 4.00 |
| PEG-150 Pentaerythrityl Tetrastearate | 1.50 |
| Compound of Example 1 | 2.5 |
| Part C | |
| Methylchloroisothiazolinone and | 0.05 |
| Methylisothiazolinone | |
| Citric acid | Adjust to pH 6.0-6.5 |

The ingredients are combined according to the following procedure: (1) heat together all ingredients of Part A at 65° C. with moderate agitation, (2) melt Part B in a separate container and add to Part A when melted, (3) cool mixtures to 40° C. and add Part C in the order listed and (4) adjust pH to 6.0-6.5 by addition of sufficient amount of citric acid.

### EXAMPLE 10

The leave-in conditioner composition of Example 10 is made by combining the ingredients in Table XI according to the procedure set forth below and can be sprayed onto the hair and used throughout the day to provide shine and conditioning.

TABLE XI

| | Relative |
|---|---|
| Ingredient | Amount |
| Phenyl Trimethicone | 10.0 |
| Cyclopentasiloxane | 85.0 |
| Compound of Example 1 | 5.0 |

The ingredients are combined according to the following procedure: (1) mix together phenyl trimethicone and cyclopentasiloxane until uniform, and (2) add the silicone composition of Example 1 with stirring.

### EXAMPLE 11

The rinse-off conditioner composition of Example 11 is made by combining the ingredients set forth below in Table XII according to the procedure set forth below and gives excellent conditioning effects to hair which are soft, smooth, and silky feel.

TABLE XII

| | Relative |
|---|---|
| Ingredient | Amount |
| Part A | |
| Deionized water | q.s. |
| Hydroxyethylcellulose | 0.50 |
| Glycerin | 2.00 |
| Methylparaben | 0.20 |
| Propylparaben | 0.10 |
| Part B | |
| Cetearyl alcohol, Dicetyldimonium | 3.00 |
| Chloride and Stearamidopropyl | |
| Dimethylamine | |
| Glyceryl Stearate | 0.80 |
| Compound of Example 1 | 3.00 |
| Cetyl Alcohol | 1.50 |
| Part C | |
| Methylchloroisothiazolinone(and) | 0.05 |
| Methylisothiazolinone | |

The ingredients are combined according to the following procedure: (1) heat together all ingredients of Part A at 65° C., (2) melt Part B in a separate container and add to Part A when melted, and (3) cool mixtures to 40° C. and add Part C in the order listed.

The branched organosiloxane compound of the present invention exhibits a high affinity for a wide variety of fluids, including emollient fluids. The silicone composition of the present invention exhibits good stability, that is, a high resistance to separation of the fluid from the silicone composition. Personal care compositions containing branched organosiloxane compound and an emollient fluid, whether the branched organosiloxane compound and fluid are added separately to the personal care composition or added to the personal care composition in the form of the silicone composition of the present invention, exhibit improved sensory feel, leave a smooth silky feeling in the skin upon dry down, exhibit good film forming ability and exhibit good stability, that is, a high resistance to separation of the emollient fluid from the personal composition.

1. A branched organosiloxane silicone composition comprising a silicone resin core wherein said silicone resin core comprises:
(a) two or more siloxane units of the structural formula (I):
SiO_{4/2} (I)
wherein said siloxane units are covalently bonded, either directly to each other or indirectly via one or more bridging organosiloxane groups and
(b) one or more terminal groups having the structural formula (II):
R¹₃SiO_{1/2} (II)
wherein said the said bridging organosiloxane groups are selected from the group of organosiloxanes having the structural formulas (III) and (IV):
R²₂SiO_{2/2} (III)
R³SiO_{3/2} (IV)
wherein each R¹ in each terminal group (I), each R² in each bridging group (III) and each R³ in each bridging group (IV) is independently a hydrocarbon radical.

2. The composition of claim 1 wherein each R¹ in each terminal group (I), each R² in each bridging group (III) and each R³ in each bridging group (IV) is independently an alicyclic hydrocarbon radical.

3. The composition of claim 2 where at least one of R¹, R² and R³ is selected from the group of hydrocarbon radicals having from 1 to 70 carbon atoms per radical and where at least one of R¹, R² and R³ is selected from the group of hydrocarbon radicals having from 10 to 80 carbon atoms per radical.

4. The composition of claim 3 where at least one of R¹, R² and R³ is selected from the group of hydrocarbon radicals having from 1 to 60 carbon atoms per radical and where at least one of R¹, R² and R³ is selected from the group of hydrocarbon radicals having from 20 to 80 carbon atoms per radical.

5. The composition of claim 4 where at least one of R¹, R² and R³ is selected from the group of hydrocarbon radicals having from 1 to 50 carbon atoms per radical and where at least one of R¹, R² and R³ is selected from the group of hydrocarbon radicals having from 30 to 80 carbon atoms per radical.

6. The composition of claim 5 where at least one of R¹, R² and R³ is selected from the group of hydrocarbon radicals having from 1 to 40 carbon atoms per radical and where at least one of R¹, R² and R³ is selected from the group of hydrocarbon radicals having from 40 to 80 carbon atoms per radical.

7. The composition of claim 1 wherein said silicone is benzene soluble.

8. The composition of claim 1 wherein said silicone has a viscosity ranging from 1 to 1,000,000 cSt.

9. The composition of claim 6 wherein said silicone is benzene soluble.

10. The composition of claim 6 wherein said silicone has a viscosity ranging from 1 to 1,000,000 cSt.

11. A branched organosiloxane silicone composition comprising a network wherein said network comprises:
(a) a silicone resin core wherein said silicone resin core comprises:
(i) two or more siloxane units of the structural formula (I):
SiO_{4/2} (I)
wherein said siloxane units are covalently bonded, either directly to each other or indirectly via one or more bridging organosiloxane groups and
(ii) one or more terminal groups having the structural formula (II):
R¹₃SiO_{1/2} (II)
wherein said the said bridging organosiloxane groups are selected from the group of organosiloxanes having the structural formulas (III) and (IV):
R²₂SiO_{2/2} (III)
R³SiO_{3/2} (IV)
wherein each R¹ in each terminal group (I), each R² in each bridging group (III) and each R³ in each bridging group (IV) is independently a hydrocarbon radical and
(b) a fluid within the network.

12. The composition of claim 11 wherein said fluid within said network is a linear branched or cyclic organopolysiloxane fluid according to the formula (XIX):
M′ₚD′_{q}T′ᵣ (XIX)
wherein:
M′ is R²⁶₃SiO_{1/2};
D′ is R²⁷₂SiO_{2/2}
T′ is R²⁸SiO_{3/2}
R²⁶, R²⁷ and R²⁸ are each independently alkyl, aryl or aralkyl;
p, q and r are zero or positive integers, 0≦q≦300, and when p and r are both zero, q is 3 or greater.

13. The composition of claim 12 wherein each R¹ in each terminal group (I), each R² in each bridging group (III) and each R³ in each bridging group (IV) is independently an alicyclic hydrocarbon radical.

14. The composition of claim 13 where at least one of R¹, R² and R³ is selected from the group of hydrocarbon radicals having from 1 to 70 carbon atoms per radical and where at least one of R¹, R² and R³ is selected from the group of hydrocarbon radicals having from 10 to 80 carbon atoms per radical.

15. The composition of claim 14 where at least one of R¹, R² and R³ is selected from the group of hydrocarbon radicals having from 1 to 60 carbon atoms per radical and where at least one of R¹, R² and R³ is selected from the group of hydrocarbon radicals having from 20 to 80 carbon atoms per radical.

16. The composition of claim 15 where at least one of R¹, R² and R³ is selected from the group of hydrocarbon radicals having from 1 to 50 carbon atoms per radical and where at least one of R¹, R² and R³ is selected from the group of hydrocarbon radicals having from 30 to 80 carbon atoms per radical.

17. The composition of claim 16 where at least one of R¹, R² and R³ is selected from the group of hydrocarbon radicals having from 1 to 40 carbon atoms per radical and where at least one of R₁, R² and R³ is selected from the group of hydrocarbon radicals having from 40 to 80 carbon atoms per radical.

18. The composition of claim 11 wherein said silicone is benzene soluble.

19. The composition of claim 11 wherein said silicone has a viscosity ranging from 1 to 1,000,000 cSt.

20. The composition of claim 17 wherein said silicone is benzene soluble.

21. The composition of claim 17 wherein said silicone has a viscosity ranging from 1 to 1,000,000 cSt.

22. A water-in-oil emulsion comprising the composition of claim 1.

23. An oil-in water emulsion comprising the composition of claim 1.

24. A non-aqueous emulsion wherein the continuous phase comprises the composition of claim 1.

25. A non-aqueous emulsion wherein the discontinuous phase comprises the composition of claim 1.

26. A cosmetic composition comprising a branched organosiloxane silicone composition comprising a silicone resin core wherein said silicone resin core comprises:
(a) two or more siloxane units of the structural formula (I):
SiO_{4/2} (I)
wherein said siloxane units are covalently bonded, either directly to each other or indirectly via one or more bridging organosiloxane groups and
(b) one or more terminal groups having the structural formula (II):
R¹₃SiO_{1/2} (II)
wherein said the said bridging organosiloxane groups are selected from the group of organosiloxanes having the structural formulas (III) and (IV):
R²₂SiO_{2/2} (III)
R³SiO_{3/2} (IV)
wherein each R¹ in each terminal group (I), each R² in each bridging group (III) and each R³ in each bridging group (IV) is independently a hydrocarbon radical.

27. The cosmetic composition of claim 26 comprising a water-in-oil emulsion.

28. The cosmetic composition of claim 26 comprising an oil-in-water emulsion.

29. The cosmetic composition of claim 26 comprising a non-aqueous emulsion wherein the continuous phase comprises a silicone.

30. The cosmetic composition of claim 26 comprising a non-aqueous emulsion wherein the discontinuous phase comprises a silicone.
